(19) United States
(12) Patent Application Publication
(10) Pub. No.: US 2017/0038537 A1
(43) Pub. Date: Feb. 9, 2017

(54) MPOwer Connector

(71) Applicant: CommScope, Inc. of North Carolina, Hickory, NC (US)

(72) Inventors: Brian K. BUSHNELL, Wylie, TX (US); Earl R. PARSONS, Allen, TX (US)

(73) Assignee: CommScope, Inc. of North Carolina

(21) Appl. No.: 15/225,792

(22) Filed: Aug. 1, 2016

Related U.S. Application Data
(60) Provisional application No. 62/201,571, filed on Aug. 5, 2015.

(51) Int. Cl. G02B 6/38; H01R 13/426; H01R 24/28

(52) U.S. Cl. CPC G02B 6/3817; G02B 6/3882; G02B 6/3893; G02B 6/3885; H01R 24/28; H01R 13/426; H01R 2103/00

(57) ABSTRACT

An MPO connector includes a ferrule. A plurality of fiber ends are situated in at least one row located on a mating face of the ferrule. In a first embodiment, first and second terminals are formed by first and second conductive pins extending out of the ferrule at the mating face. In a second embodiment, the first and second terminals are formed by first and second conductive sleeves extending into the ferrule at the mating face. In a third embodiment, the first and second terminals are formed by the first conductive sleeve extending into the ferrule at the mating face, and the second conductive pin extending out of the ferrule at the mating face. In each embodiment, at least one conductor is attached to at least one of the first and second terminals.

This application claims the benefit of U.S. Provisional Application No. 62/201,571, filed Aug. 5, 2015, which is herein incorporated by reference.

### BACKGROUND OF THE INVENTION

1. Field of the Invention

The present invention relates to a connector. More particularly, the present invention relates to an MPO style or type of connector, wherein the alignment pins, sockets, or pin/socket are electrically connected to two separate conductors, so as to enable the transfer of power or communication signals.

2. Description of the Related Art

Cords and cables with multiple-fiber push-on/pull-off (MPO) connectors are generally known in the art. Such connectors relate to IEC-61754-7 and EIA/TIA 604-5 (FOCIS 5) standards, which are incorporated herein by reference. MPO patch cords have MPO connectors that typically exist in two genders—male with alignment pins or female without alignment pins.

In FIG. 1, reference numeral 11 denotes a male MPO connector, in accordance with the prior art. In initial construction, the male MPO connector 11 has first and second holes 13 and 15 formed in a termination end, mating face or front face 17 of a first ferrule 18. First and second alignment pins 19 and 21 reside within the first and second holes 13 and 15, respectively, and protrude away from the front face 17 of the first ferrule 18.

Fiber ends 23 are located in a single row and are aligned between the first and second alignment pins 19 and 21. Although FIG. 1 illustrates eight fiber ends 23 located between the first and second alignment pins 19 and 21, it is known to have twelve fiber ends in a single row, twenty-four fiber ends in two rows, forty-eight fiber ends in four rows, or seventy-two fiber ends in six rows between the first and second alignment pins 19 and 21.

FIG. 2 illustrates a pin clamp 25, which is assembled into the male MPO connector 11. The pin clamp 25, which is typically formed of a conductive metal, holds ends of the first and second alignment pins 19 and 21, so that the first and second alignment pins 19 and 21 are well anchored within the front face 17 of the first ferrule 18 and not easily removed from the male MPO connector 11 during mating and un-mating of the male MPO connector 11 with a female MPO connector or female MPO port.

In FIG. 3, reference numeral 27 denotes a female MPO connector, in accordance with the prior art. The female MPO connector 27 has third and fourth holes 29 and 31 formed in a termination end or front face 33 of a second ferrule 35. The third and fourth holes 29 and 31 are empty and do not possess any alignment pins. Rather, the third and fourth holes 29 and 31 are provided as guidance holes to receive the first and second alignment pins 19 and 21 of a mating male MPO connector 11 or mating male MPO port.

Fiber ends 37 are located in a single row and are aligned between the third and fourth holes 29 and 31. Although FIG. 3 illustrates eight fiber ends 37 located between the third and fourth holes 29 and 31, it is known to have twelve fiber ends in a single row, twenty-four fiber ends in two rows, forty-eight fiber ends in four rows, or seventy-two fiber ends in six rows between the third and fourth holes 29 and 31.

FIG. 4 illustrates a spacer clamp 39, which is assembled into the female MPO connector 27. The spacer clamp 39 has dimensions similar to the pin clamp 25 of FIG. 2, and may be formed of a same material. The spacer clamp 39 may assist in manufacturing the female MPO connector 27, such that the female MPO connector 27 may be manufactured using process steps and equipment similar to the process steps and equipment used to manufacture the male MPO connectors 11, except that the step of inserting the first and second alignment pins 19 and 21 is omitted.

A genderless or hermaphroditic MPO connector, having one pin and one hole, is also known in the prior art. U.S. published Applications 2001/0007603; 2004/0117981 and 2011/0249943, each of which is herein incorporated by reference, show genderless MPO connectors.

Additional background art can be seen in U.S. Pat. Nos. 7,391,572 and 7,898,736, each of which is herein incorporated by reference. In U.S. Pat. Nos. 7,391,572 and 7,898,736, metallic pins are described as being formed as alignment pins or electrical connectors. A second embodiment in the two patents shows pins, of a different connector, being attached to a computer backplane.

### SUMMARY OF THE INVENTION

The Applicant has appreciated that the typical male MPO connector includes two alignment pins, which are typically formed of a metal which are connected to each other by a metal pin clamp. Most metals are conductive and hence the two alignment pins are electrically connected. It would be no change to the outer configuration, shape or dimensions of a standard male MPO connector to fabricate the alignment pins from a highly conductive metal, such as copper, or a copper, silver, or gold clad steel and to form the inner pin clamp of a nonconductive material, in accordance with one embodiment of the present invention.

Typical female MPO connectors have two holes formed in the non-conductive ferrule body and no conductive metal is present in the holes. However, by another embodiment of the present invention, the holes could be surrounded or lined by a conductive sleeve to receive the conductive pins of the male MPO connector.

In the case of the genderless MPO connector, having one alignment pin and one alignment hole, another embodiment of the present invention would form the alignment pin of a conductive metal and surround the alignment hole with a conductive sleeve.

In each embodiment, each alignment pin and/or conductive sleeve may be electrically connected to a first or second terminal of the MPO connector.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front perspective view of a male MPO connector, in accordance with the prior art;

FIG. 2 is a front perspective view of a pin clamp employed within the male MPO connector of FIG. 1;

FIG. 3 is a front perspective view of a female MPO connector, in accordance with the prior art;

FIG. 4 is a front perspective view of a spacer clamp employed within the female MPO connector of FIG. 3;

FIG. 5 is a front perspective view of a pin clamp holding a pin and a sleeve, in accordance with a first embodiment of the present invention;

FIG. 6 is a front perspective view of a MT-type ferrule housing the first pin clamp of FIG. 5;

FIG. 7 is a front perspective view of a MPO connector housing the MT-type ferrule of FIG. 6;

FIG. 8 is a front perspective view of a pin clamp holding two pins;

FIG. 9 is a front perspective view of a MPO connector housing a MT-type ferrule with the pin clamp of FIG. 8;

FIG. 10 is a front perspective view of a pin clamp holding two sleeves; and

FIG. 11 is a front perspective view of a MPO connector housing a MT-type ferrule with the pin clamp of FIG. 10.

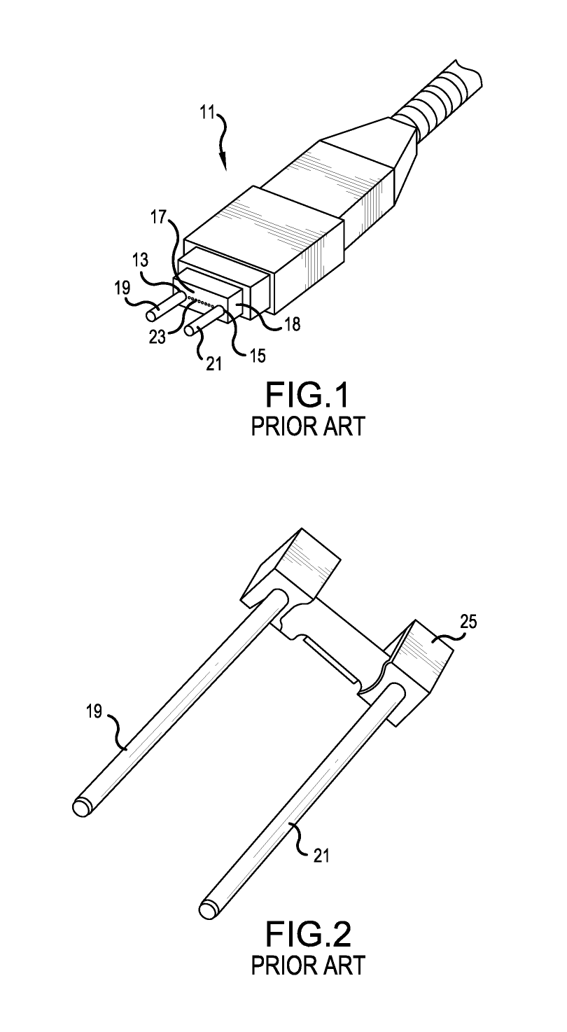

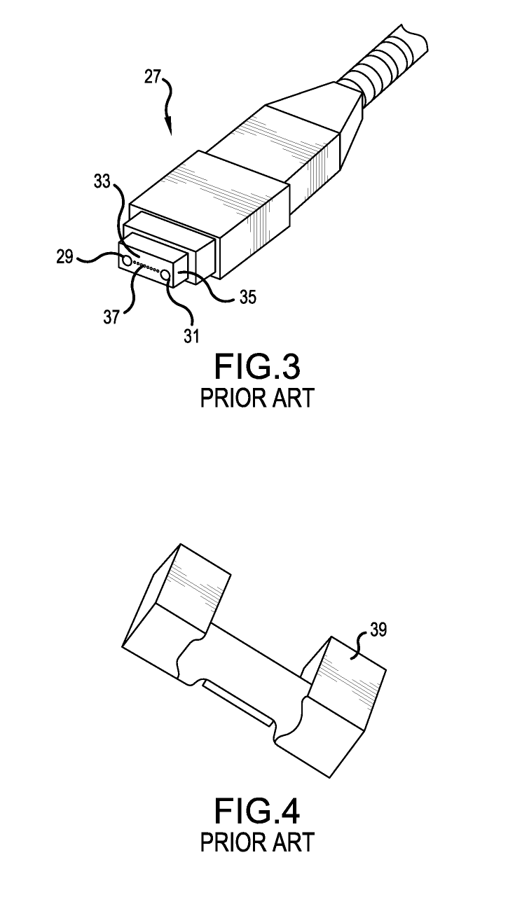

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y. As used herein, phrases such as from about X to Y” mean from about X to about Y.

It will be understood that when an element is referred to as being on, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

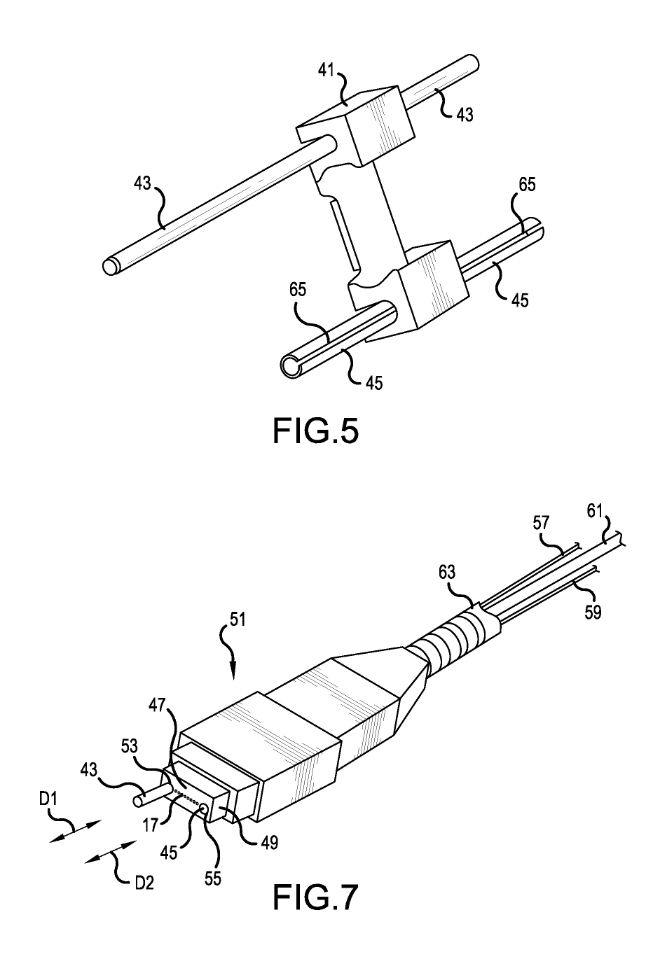

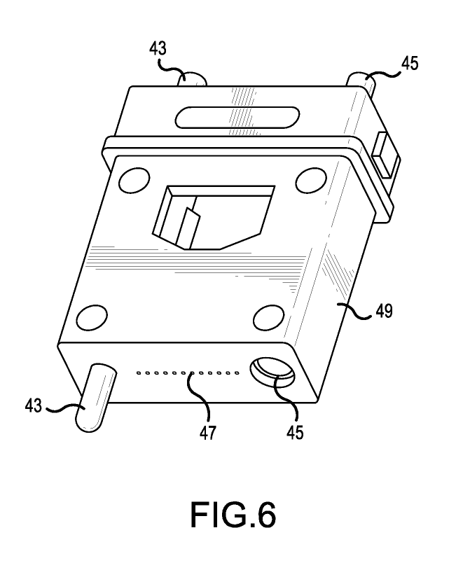

FIG. 5 is a front perspective view of a first pin clamp 41, in accordance with a first embodiment of the present invention. The first pin clamp 41 holds a first alignment pin 43 and a first alignment sleeve 45, so that the first alignment pin 43 and first alignment sleeve 45 are well anchored and will not easily pull free from a front or mating face 47 of a ferrule 49 (See FIGS. 6 and 7) during connector mating and un-mating operations. The first alignment pin 43 is formed of a conductive material, such as copper, or a clad material, like copper, silver or gold clad steel. Likewise, the first alignment sleeve 45 is formed of a conductive material. The first pin clamp 41 is preferably formed of a non-conductive material, such as a ceramic or plastic, so that electrical conductivity is not established between the first alignment pin 43 and the first alignment sleeve 45.

In one embodiment and as best seen in FIG. 6 below, the first alignment pin 43 passes entirely through the ferrule 49, e.g., an MT-type ferrule, to a backside of the ferrule 49, opposite to the mating face 47. Also, the first alignment sleeve 45 passes entirely through the ferrule 49 to a backside of the ferrule 49, opposite to the mating face 47. The backside ends of the first alignment pin 43 and the first alignment sleeve 45 function as wire connections to which wires may be electrically connected. If power is to be transmitted through the alignment pin and sleeve, the first alignment pin 43 may serve as a first terminal or positive terminal, and the first alignment sleeve 45 may serve as a second terminal or negative terminal. Of course, the polarity may be reversed if desired.

FIG. 7 is a front perspective view of a first MPO connector 51 into which the ferrule 49 has been installed. The first terminal is formed by the conductive first alignment pin 43. The first alignment pin 43 resides within a first opening 53 in the mating face 47 of the ferrule 49 and extends in a first direction D1. The second terminal is formed by the conductive first alignment sleeve 45. The first alignment sleeve 45 resides within a second opening 55 in the front face 47 of the ferrule 49 and extends in a second direction D2. The second direction D2 is parallel to the first direction D1.

A plurality of fiber ends 17 are situated in at least one row located on the mating face 47. The first alignment pin 43 extends out of the first opening 53 of the ferrule 49 and away from the mating face 47. The first alignment sleeve 45 is aligned within the second opening 55 in the mating face 47 and extends into the ferrule 49 away from the mating face 47. The plurality of fiber ends 17 are situated between the first alignment pin 43 and the second opening 55 leading to the first alignment sleeve 45.

As best seen in FIG. 7, a first conductor 57, e.g. an insulated wire, is attached to the first terminal, e.g., a back end of the first alignment pin 43. A second conductor 59, e.g., an insulated wire, is attached to the second terminal, e.g., a back end of the first alignment sleeve 45. Optical fibers 61, such as a ribbon cable or a loose tube containing plural single fibers, pass into the ferrule 49 and terminate as the fiber ends 17. The first conductor 57, second conductor 59 and optical fibers 61 may be surrounded by a common jacket 63 of a cable terminated to the first MPO connector 51.

As best seen in FIG. 5, the first alignment sleeve 45 may be formed in the shape an open-ended cylinder formed of a resilient metal with an open gap 65 extending in the second direction D2. The open gap 65 may enlarge against the resiliency of the metal to allow a first alignment pin 43 of another, similarly configured MPO connector, mated to the MPO connector 51, to enter the first alignment sleeve 45.

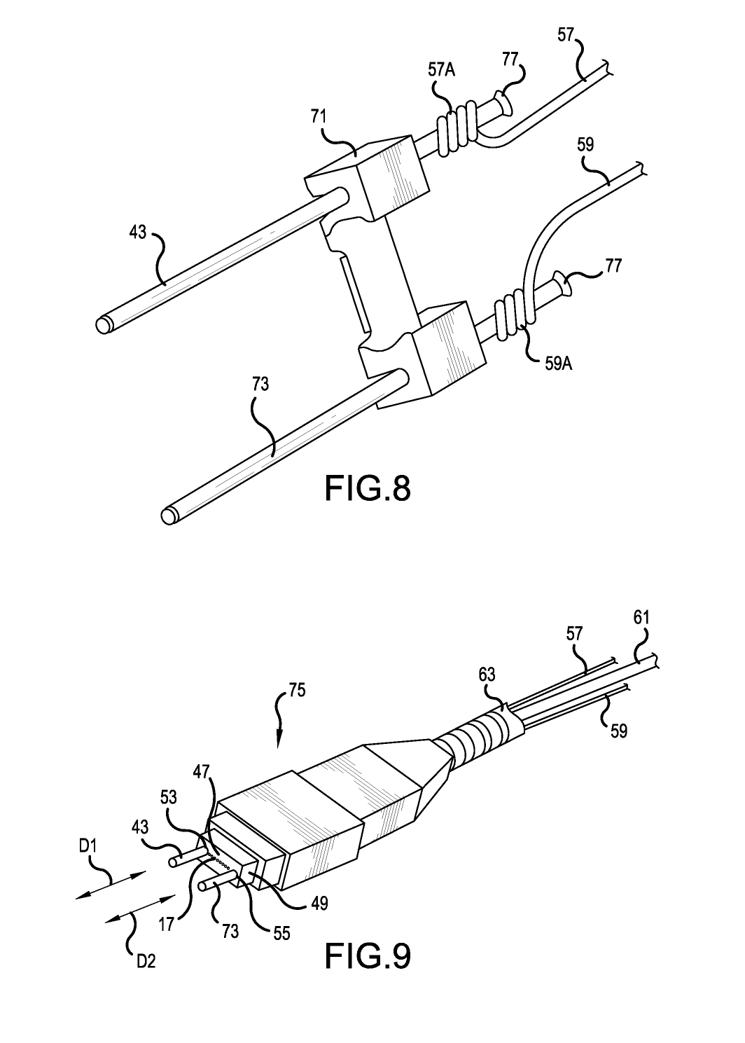

FIG. 8 is a front perspective view of a second pin clamp 71, in accordance with a second embodiment of the present invention. The second pin clamp 71 holds the first alignment pin 43 and a second alignment pin 73, so that the first alignment pin 43 and the second alignment pin 73 are well anchored and will not easily pull free from the mating face 47 of the ferrule 49 (See FIG. 9) during connector mating and un-mating operations. The first alignment pin 43 and the second alignment pin 73 are formed of a conductive material. The second pin clamp 71 is preferably formed of a non-conductive material, such as a ceramic or plastic, so that electrical conductivity is not established between the first alignment pin 43 and the second alignment pin 73.

Like the first embodiment, the first alignment pin 43 and the second alignment pin 73 may pass entirely through the ferrule 49, e.g., an MT-type ferrule, to a backside of the ferrule 49, opposite to the mating face 47. Also, the backside ends of the first and second alignment pins 43 and 73 may function as wire connections. If power is to be transmitted, the first alignment pin 43 may serve as a first terminal or positive terminal and the second alignment pin 73 may serve as a second terminal or negative terminal, or vice versa.

FIG. 9 is a front perspective view of a second MPO connector 75, into which the ferrule 49 has been installed. The first terminal is formed by the conductive, first alignment pin 43. The first alignment pin 43 resides within the first opening 53 in the mating face 47 of the ferrule 49 and extends in the first direction D1. The second terminal is formed by the conductive, second alignment pin 73. The second alignment pin 73 resides within the second opening 55 in the mating face 47 of the ferrule 49 and extends in the second direction D2.

The plurality of fiber ends 17 are situated in at least one row located on the mating face 47. The first alignment pin 43 extends out of the first opening 53 of the ferrule 49 and away from the ferrule 49. The second alignment pin 73 extends out of the second opening 55 of the ferrule 49 and away from the ferrule 49. The plurality of fiber ends 17 are situated between the first alignment pin 43 and the second alignment pin 73.

As best seen in FIG. 9, the first conductor 57, e.g. an insulated wire, is attached to the first terminal, e.g., a backside end of the first alignment pin 43. The second conductor 59, e.g., an insulated wire, is attached to the second terminal, e.g., a backside end of the second alignment pin 73. The optical fibers 61, such as a ribbon cable or a loose tube containing plural single fibers, pass into the ferrule 49 and terminate as the fiber ends 17. The first conductor 57, second conductor 59 and optical fibers 61 may be surrounded by the common jacket 63 of the cable terminated to the second MPO connector 75.

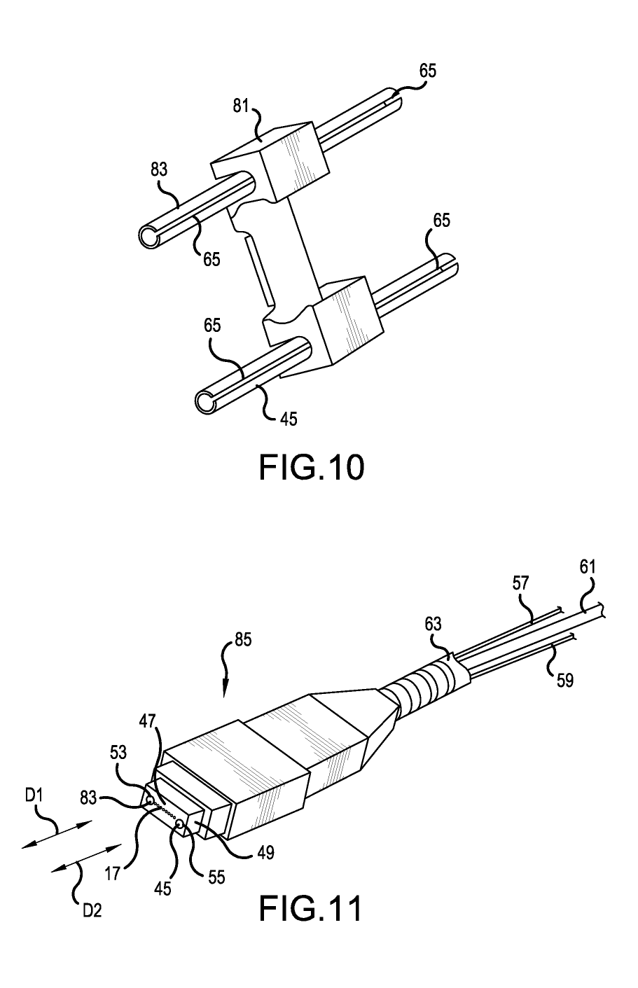

FIG. 10 is a front perspective view of a third pin clamp 81, in accordance with a third embodiment of the present invention. The third pin clamp 81 holds the first alignment sleeve 45 and a second alignment sleeve 83, so that the first alignment sleeve 45 and second alignment sleeve 83 are well anchored and will not easily pull free from the mating face 47 of the ferrule 49 (See FIG. 11) during connector mating and un-mating operations. The first alignment sleeve 45 and the second alignment sleeve 83 are formed of a conductive material. The third pin clamp 81 is preferably formed of a non-conductive material, such as a ceramic or plastic, so that electrical conductivity is not established between the first alignment sleeve 45 and the second alignment sleeve 83.

Like the first embodiment, the first alignment sleeve 45 and the second alignment sleeve 83 may pass entirely through the ferrule 49, e.g., an MT-type ferrule, to a backside of the ferrule 49, opposite to the mating face 47. Also, the backside ends of the first and second alignment sleeves 45 and 83 may function as wire connections. If power is to be transmitted, the first alignment sleeve 45 may serve as a first terminal or positive terminal and the second alignment sleeve 83 may serve as a second terminal or negative terminal, or vice versa.

FIG. 11 is a front perspective view of a third MPO connector 85 into which the ferrule 49 has been installed. The first terminal is formed by the conductive, first alignment sleeve 45. The first alignment sleeve 45 resides within the second opening 55 in the mating face 47 of the ferrule 49 and extends in the second direction D2. The second terminal is formed by the conductive, second alignment sleeve 83. The second alignment sleeve 83 resides within the first opening 53 in the mating face 47 of the ferrule 49 and extends in the first direction D1.

The plurality of fiber ends 17 are situated in at least one row located on the mating face 47. The first alignment sleeve 45 is aligned within the second opening 55 of the ferrule 49 and extends into the ferrule 49 away from the mating face 47. The second alignment sleeve 83 is aligned within the first opening 53 of the ferrule 49 and extends into the ferrule 49 away from the mating face 47. The plurality of fiber ends 17 are situated between the first opening 53 and the second opening 55.

As best seen in FIG. 11, the first conductor 57, e.g. an insulated wire, is attached to the first terminal, e.g., a backside end of the first alignment sleeve 45. The second conductor 59, e.g., an insulated wire, is attached to the second terminal, e.g., a backside end of the second alignment sleeve 83. The optical fibers 61, such as a ribbon cable or a loose tube containing plural single fibers, pass into the ferrule 49 and terminate as the fiber ends 17. The first conductor 57, second conductor 59 and optical fibers 61 may be surrounded by the common jacket 63 of the cable terminated to the third MPO connector 85.

As with the first embodiment, the first alignment sleeve 45 and second alignment sleeve 83 may be formed in the shape an open-ended cylinder formed of a resilient metal with an open gap 65. The open gaps 65 may enlarge against the resiliency of the metal to allow a first alignment pin 43 and a second alignment pin 73 of a second MPO connector 75 (FIG. 9), mated to the third MPO connector 85, to enter the first alignment sleeve 45 and the second alignment sleeve 83.

As noted in the above embodiments, the first and second conductors 57 and 59 are electrically connected to the first and second terminals, e.g., alignment pins and/or sleeves. In one embodiment, the first and second conductors 57 and 59 may be embodied by twenty-two gauge insulated conductors. Twenty-two gauge conductors have a diameter of about 0.64516 mm (slightly less than the diameter of the alignment pins 43 or 73, which is about 0.698 mm). A twenty-two gauge wire can carry about 7.0 amps. Of course, larger diameter wires may be used, or parallel wires may be used, if greater amperages are desired.

The attachment between the first and second conductors 57 and 59 and the first and second terminals may be by any known manner, such as a wire wrap, soldering, screw terminal or insulation displacement connector (IDC). In the case of a wire wrap, the backside ends of the alignment pin or alignment sleeve may include a flare 77, as illustrated in FIG. 8, to assist in retaining wire wrap sections 57A and 59A of the first and second conductors 57 and 59 on the alignment pins and/or sleeves.

The power transmission system may be used to power a remote cell antenna, in-line optical signal amplifier, optical-to-electrical (O/E) transducer, electrical-to-optical (E/O) transducer, wireless network module or other equipment. The first and/or second conductors 57 and 59 may also be used for communication signaling, e.g., for data transmissions. For example, the first and second conductors 57 and 59 may be a twisted pair and be used to transmit a differential communication signal to the first and second terminals. Further, the first and/or second conductors 57 and 59 may be used for intelligent patch cord tracing purposes in systems such as the IPatch™ system. In such a system, the first or second conductor 57 or 59 may function as essentially a “ninth wire,” e.g., a wire which passes an electrical signal or voltage to indicate a connection by a patch cord between two ports on a patch panel. Alternatively, the first and second conductors 57 and 59 may both be used to pass an electrical signal or voltage to indicate a connection by a patch cord between two ports on a patch panel. The indication may include powering indicator LEDs at MPO ports to indicate attachment points for ends of MPO patch cords on a patch panel and/or creating a computer-based mapping of the attachment points.

Although a single row of eight fiber ends 17 has been depicted in FIGS. 7, 9 and 11, any number of rows and any number of fiber ends 17 may be employed, such as twelve fiber ends 17 in a single row, sixteen fiber ends 17 in two rows, twenty-four fiber ends 17 in two rows, twenty-four fiber ends 17 in three rows, forty-eight fiber ends 17 in four rows, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. An apparatus comprising:
a MPO connector including:
a ferrule;
a first conductive pin residing within said ferrule and extending in a first direction, and forming a first terminal;
a second pin residing within said ferrule and extending in a second direction, wherein said second direction is parallel to said first direction; and
a plurality of fiber ends situated in at least one row located on a mating face of said ferrule, wherein said first conductive pin extends out of said ferrule and away from said mating face; wherein said second pin extends out of said ferrule and away from said mating face, and wherein said plurality of fiber ends are situated between said first conductive pin and said second pin; and
a first conductor attached to said first conductive pin.

2. The apparatus according to claim 1, wherein said second pin is conductive and forms a second terminal, and further comprising:
a second conductor attached to said second conductive pin;
wherein said first conductive pin passes through said ferrule to a backside of said ferrule, opposite to said mating face;
wherein said second conductive pin passes through said ferrule to said backside of said ferrule;
wherein said first conductor is a first wire attached to said first conductive pin at said backside of said ferrule; and
wherein said second conductor is a second wire attached to said second conductive pin at said backside of said ferrule.

3. The apparatus according to claim 2, further comprising:
a nonconductive clamp residing inside said ferrule, wherein said first and second conductive pins are attached to said nonconductive clamp.

4. The apparatus according to claim 2, wherein said MPO connector is attached to an end of a cable, and wherein optical fibers leading to said plurality of fiber ends, said first conductor and said second conductor are jacketed within said cable.

5. The apparatus according to claim 2, wherein said first terminal constitutes a positive terminal for supplying power and said second terminal constitutes a negative terminal for supplying power.

6. The apparatus according to claim 1, wherein said first terminal constitutes a first communication terminal for supplying a communication signal.

7. The apparatus according to claim 2, wherein said first terminal constitutes a first communication terminal for supplying a differential communication signal and said second terminal constitutes a second communication terminal for supplying the differential communication signal.

8. An apparatus comprising:
a MPO connector including:
a ferrule;
a first conductive sleeve residing within a first opening in a mating face of said ferrule and extending in a first direction, and forming a first terminal;
a second opening in said mating face of said ferrule and extending in a second direction, wherein said second direction is parallel to said first direction; and
a plurality of fiber ends situated in at least one row located on said mating face of said ferrule, wherein said plurality of fiber ends are situated between said first opening and said second opening; and
a first conductor attached to said first conductive sleeve.

9. The apparatus according to claim 8, further comprising:
a second conductive sleeve residing within said second opening in said mating face of said ferrule and extending in said second direction, and forming a second terminal;
a second conductor attached to said second conductive sleeve;
wherein said first conductive sleeve passes through said ferrule to a backside of said ferrule, opposite to said mating face;
wherein said second conductive sleeve passes through said ferrule to said backside of said ferrule;
wherein said first conductor is a first wire attached to said first conductive sleeve at said backside of said ferrule; and
wherein said second conductor is a second wire attached to said second conductive sleeve at said backside of said ferrule.

10. The apparatus according to claim 9, further comprising:
a nonconductive clamp residing inside said ferrule, wherein said first and second conductive sleeves are attached to said nonconductive clamp.

11. The apparatus according to one of claim 9, wherein said first and second conductive sleeves are each formed in the shape of an open-ended cylinder of a resilient metal with an open gap, and wherein the open gap may enlarge against the resiliency of the metal to allow a pin to enter the sleeve.

12. The apparatus according to claim 9, wherein said first terminal constitutes a positive terminal for supplying power and said second terminal constitutes a negative terminal for supplying power.

13. The apparatus according to claim 8, wherein said first terminal constitutes a first communication terminal for supplying a communication signal.

14. The apparatus according to claim 9, wherein said first terminal constitutes a first communication terminal for supplying a differential communication signal and said second terminal constitutes a second communication terminal for supplying the differential communication signal.

15. An apparatus comprising:
a MPO connector including:
a ferrule;
a conductive pin residing within said ferrule and extending in a first direction;
a conductive sleeve residing within said ferrule and extending in a second direction, wherein said second direction is parallel to said first direction; and
a plurality of fiber ends situated in at least one row located on a mating face of said ferrule, wherein said conductive pin extends out of said ferrule and away from said mating face; wherein said conductive sleeve is aligned to an opening in said mating face and extends into said ferrule away from said mating face, and wherein said plurality of fiber ends are situated between said pin and said opening; and
a first conductor attached to one of said conductive pin or said conductive sleeve.

16. The apparatus according to claim 15, wherein said first conductor is attached to said conductive pin and forms a first terminal, and further comprising:
a second conductor attached to said conductive sleeve, to form a second terminal;
wherein said conductive pin passes through said ferrule to a backside of said ferrule, opposite to said mating face;
wherein said conductive sleeve passes through said ferrule to said backside of said ferrule;
wherein said first conductor is a first wire attached to said conductive pin at said backside of said ferrule; and
wherein said second conductor is a second wire attached to said conductive sleeve at said backside of said ferrule.

17. The apparatus according to claim 16, further comprising:
a nonconductive clamp residing inside said ferrule, wherein said conductive pin and said conductive sleeve are attached to said nonconductive clamp.

18. The apparatus according to claim 16, wherein said first terminal constitutes a positive terminal for supplying power and said second terminal constitutes a negative terminal for supplying power.

19. The apparatus according to claim 15, wherein said conductor supplies a communication signal to said one of said conductive pin or said conductive sleeve.

20. The apparatus according to claim 16, wherein said first terminal constitutes a first communication terminal for supplying a differential communication signal and said second terminal constitutes a second communication terminal for supplying the differential communication signal.
